(19) United States
(12) Patent Application Publication
(10) Pub. No.: US 2015/0206110 A1
(43) Pub. Date: Jul. 23, 2015

(54) AUTOMATIC DATA TRANSFER

(71) Applicant: MasterCard International Incorporated, Purchase, NY (US)

(72) Inventors: James C. Noe, Kent (GB); Michael J. Cowen, London (GB); Jason Field, London (GB)

(21) Appl. No.: 14/573,694

(22) Filed: Dec. 17, 2014

(30) Foreign Application Priority Data
Dec. 18, 2013 (GB) 1322353.2

(51) Int. Cl. G06Q 20/10; G06Q 20/40; G06Q 20/32; G06Q 20/28

(52) U.S. Cl. CPC G06Q 20/105; G06Q 20/28; G06Q 20/409; G06Q 20/3223

(57) ABSTRACT

A computer-implemented method of automatically transferring data to each of one or more data receivers includes, for each data receiver: automatically determining if the current data within the data receiver meets a requirement for an automatic transfer of data to the data receiver to be performed; and, in dependence on the requirement being met: automatically attempting to transfer data from a first data source to the data receiver in dependence on the data within the first data source; and, if the attempt to transfer data is not successful, automatically transferring data from one of one or more further data sources, in dependence on the data within the one of the one or more data sources, to the data receiver. Advantageously, a user's experience is improved both due to the increased amount of control that a user has and the improved functionality of the system.

### CROSS REFERENCE TO RELATED APPLICATIONS

This application claims foreign priority to United Kingdom Patent Application 1322353.2, filed 18 Dec. 2013, the complete disclosure of which is expressly incorporated herein by reference in its entirety for all purposes.

### FIELD OF THE INVENTION

The present invention relates to the automatic transfer of data. A particularly preferred embodiment provides a method and system for auto-crediting one or more prepaid accounts with improved functionality.

### BACKGROUND OF THE INVENTION

Prepaid cards are gaining popularity in numerous sectors of the economy, both public and private. Public sector agencies are increasingly recognising the service improvement and savings that can be realised through the utilisation of prepaid cards for disbursement of government benefits and employee wages. Employers favour prepaid cards as a less expensive, more convenient and more secure alternative to traditional paper-based payment methods. For consumers, prepaid cards have significant advantages over cash and cheques, providing a service that makes their lives better, providing financial empowerment and inclusion to society.

Prepaid cards operate in a similar way to standard credit cards except prepaid typically signifies that the cardholder accesses pre-loaded value, rather than a line of credit. There are many possible permutations of a prepaid program. Funds can be loaded by the consumer, a corporation or a government entity, as per the individual needs and purpose of the program.

Funds loaded onto prepaid cards are typically held in a pooled account—not on the physical card itself. Unlike debit or credit cards, prepaid card transactions are always authorised online, reducing the potential for fraudulent use as compared to stored-value cards. As all transactions are recorded automatically it is possible for issuers to track when uploads and subsequent spend takes place and monitor how the funds are spent.

Today, for virtually every payment occasion, there is a prepaid product that can meet the need better, more conveniently and with more security than cash or cheques.

Prepaid products are extremely heterogeneous, as they have been developed to cater to a wide variety of customer needs. They include physical prepaid cards, as well as e-commerce and mobile money products that do not come in the form of a plastic payment card. Across physical product types, however, most prepaid products fit within the following three categories: consumer, corporate and public sector

A problem with prepaid cards is that users have, unless an automatic option is made available to them, to periodically take time to credit, or top-up, the balance of their prepaid account. If a user forgets to credit a prepaid account, eventually a service or transaction will be declined due to the open to buy balance of the prepaid account being insufficient for even small value transactions. Furthermore, a user may struggle to maintain an accurate recollection of the available balance on their prepaid account and therefore either experience an unexpected declined when trying to transact, or neglect to use their card due to the uncertainty of what may happen. This can also be detrimental to the service provider due to the poor user experience causing users to use a service less.

There are known systems that avoid the need for users of prepaid accounts to periodically credit the balance of the account by ensuring that the balance is automatically credited when it falls below a predetermined amount. However, known automatic crediting systems have very limited functionality.

There is therefore a need to improve known automatic crediting systems for prepaid accounts. More generally, there is a need to improve the user experience in systems that provide the automatic transfer of data.

### SUMMARY OF THE INVENTION

According to a first aspect of the invention, there is provided a computer-implemented method of automatically transferring data to each of one or more data receivers, the method comprising, for each data receiver: automatically determining if the current data within the data receiver meets a requirement for an automatic transfer of data to the data receiver to be performed; and, in dependence on the requirement being met: automatically attempting to transfer data from a first data source to the data receiver in dependence on the data within the first data source; and, if the attempt to transfer data is not successful, automatically transferring data from one of one or more further data sources, in dependence on the data within the one of the one or more data sources, to the data receiver.

Preferably, the method further comprises receiving, by a user interface of a user device, for each of the one or more data receivers, one or more of: data on the data receiver; data on a plurality of data sources; data describing the requirement to be met by the data within the data receiver for an automatic transfer of data to the data receiver to be performed; and data describing the data to be transferred to the data receiver.

Preferably, the method further comprises displaying, on the user interface of the user device, selectable icons representing each of the one or more data receivers; and determining one of the one or more data receivers in dependence on a user's selection of the displayed icons.

Preferably, the method further comprises displaying, on the user interface of the user device, one or more adjustable sliders and/or one or more data boxes; receiving data dependent on a user's operations on the one or more adjustable sliders and/or one or more data boxes; and determining data describing the requirement to be met by the data within the determined data receiver for an automatic transfer of data to the determined data receiver to be performed and/or data describing the data to be transferred to the determined data receiver in dependence on the user's operations on the one or more adjustable sliders and/or one or more data boxes.

Preferably, the method further comprises displaying, on the user interface of the user device, a plurality of selectable icons representing data sources of the determined data receiver; determining data providing an order of priority of the plurality of data sources in dependence on a user's selection received by the user interface; and determining, for the determined data receiver, an order of the plurality of data sources for attempting to transfer data to the data receiver in dependence on the data providing the order of priority.

Preferably, the method further comprises a system performing the operations of the first aspect.

Preferably, the method further comprises displaying, on the user interface of the user device, one or more selectable options corresponding to receivable notifications; determining a user's selection of one or more receivable notifications in dependence on a user's selection received by the user interface; and transmitting the determined user's selection of receivable notifications to the system; wherein each of the receivable notifications is associated with an event that defines when a notification, for displaying on the user interface of the user device, is sent to the user device by the system.

Preferably, the method further comprises the system: receiving a determined user's selection of notifications from the user device; and transmitting, for each of the determined user's selection of notifications, one or more notifications to the user device, in dependence on the event associated with the notification.

Preferably, the event associated with a notification is dependent on one or more of: data within a data receiver meeting the requirement for an automatic transfer of data to the data receiver to be performed; data from a data source being received by a data receiver; operational data of one or more data sources; use data of one or more data receivers; and a periodically defined time instance.

Preferably, the content of a notification sent to the user device is dependent on one or more of: data within one or more data receivers; data within one or more data sources; data transferred into one or more data receivers over a predetermined period of time; a current location of the user device; and a location of use of the user device.

Preferably, the method further comprises the system sending one or more notifications to the user device as an SMS message and/or as an email.

Preferably, the method further comprises transmitting data between the user device and the system over the internet.

Preferably, the user device is a computing device, for example a desktop computer, or portable terminal, for example a mobile telephone, smart phone, laptop or tablet device.

Preferably, the one or more data receivers and data sources are accounts, comprising financial data, supported by one or more computing systems.

Preferably, the one or more data receivers are prepaid accounts.

Preferably, the one or more data receivers are prepaid accounts of prepaid cards.

Preferably, the system comprises the one or more data receivers and the plurality of data sources.

Preferably, the system comprises: one or more entities for providing one or more data receivers and data sources; a processor for controlling the automatic transfer of data; and communication devices for communicating with the user device.

Preferably, the entities include one or more of prepaid issuers, e-money institutions or banks.

According to a second aspect, there is provided a user device configured to perform any of the above-described methods of a user device.

According to a third aspect, there is provided a system configured to perform any of the above-described methods of a system.

### DETAILED DESCRIPTION OF THE DRAWINGS

Embodiments of the present invention will now be described in detail, by way of example only, with reference to the accompanying drawings, in which:

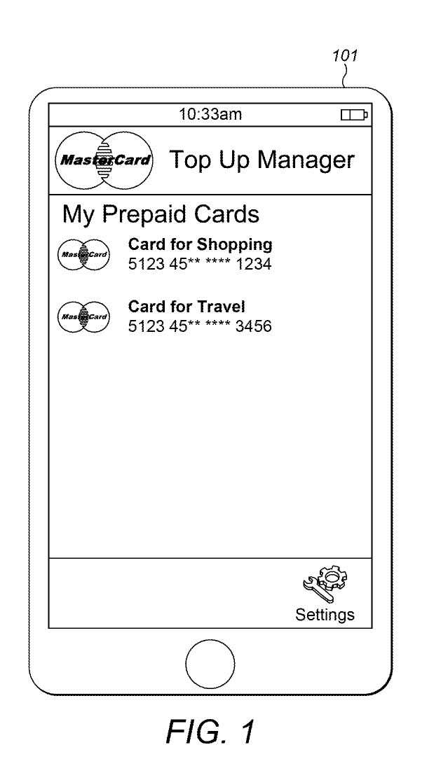

FIG. 1 shows a display on a user interface for allowing a user to select a prepaid account according to an embodiment of the invention;

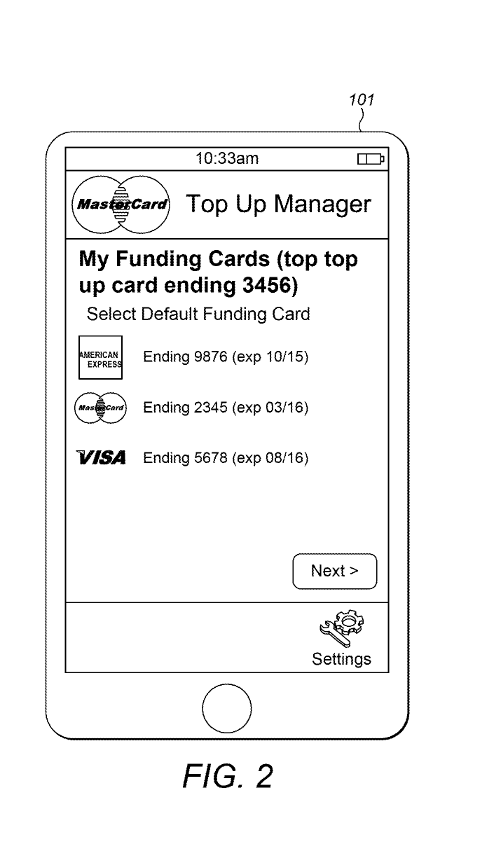

FIG. 2 shows a display on a user interface for allowing a user to select a plurality of funding sources according to an embodiment of the invention;

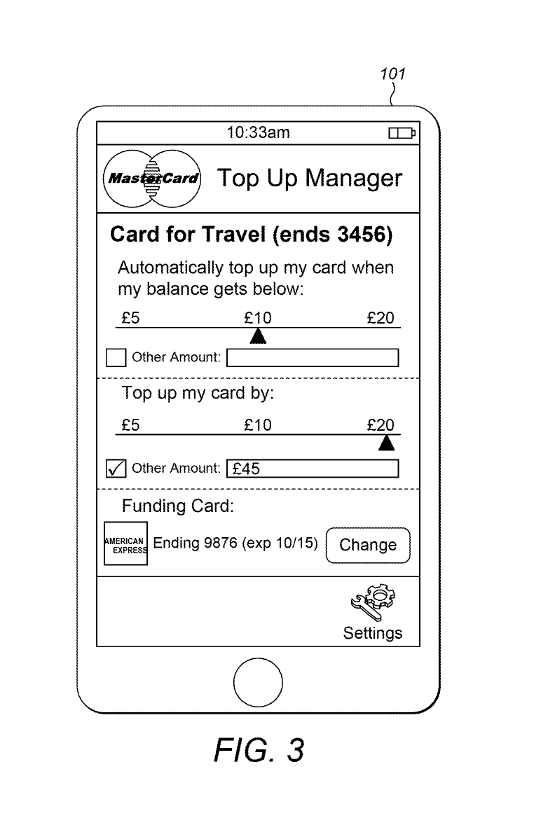

FIG. 3 shows a display on a user interface for allowing a user to control the conditions of an automatic payment according to an embodiment of the invention;

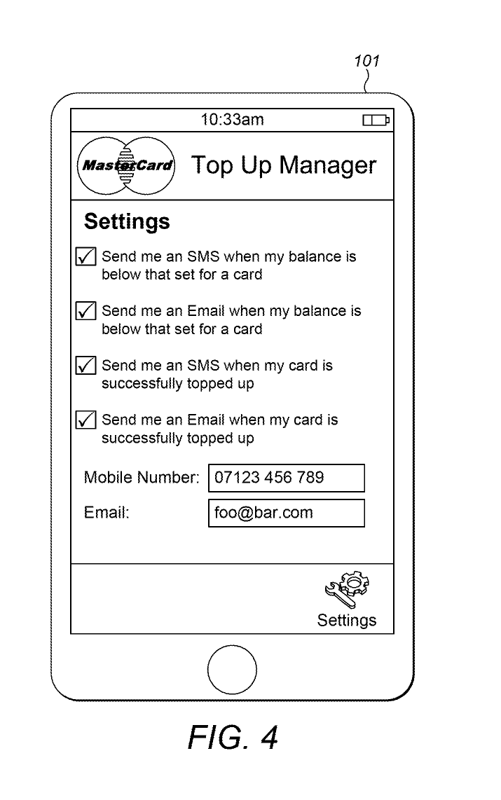

FIG. 4 shows a display on a user interface for allowing a user to control received notifications according to an embodiment of the invention;

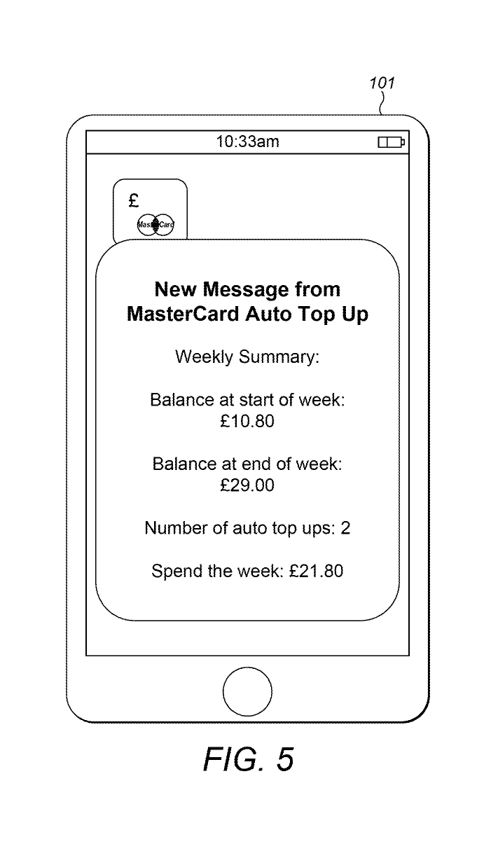

FIG. 5 shows a display of a message, on a user interface, for providing a user with detailed data on a prepaid account according to an embodiment of the invention;

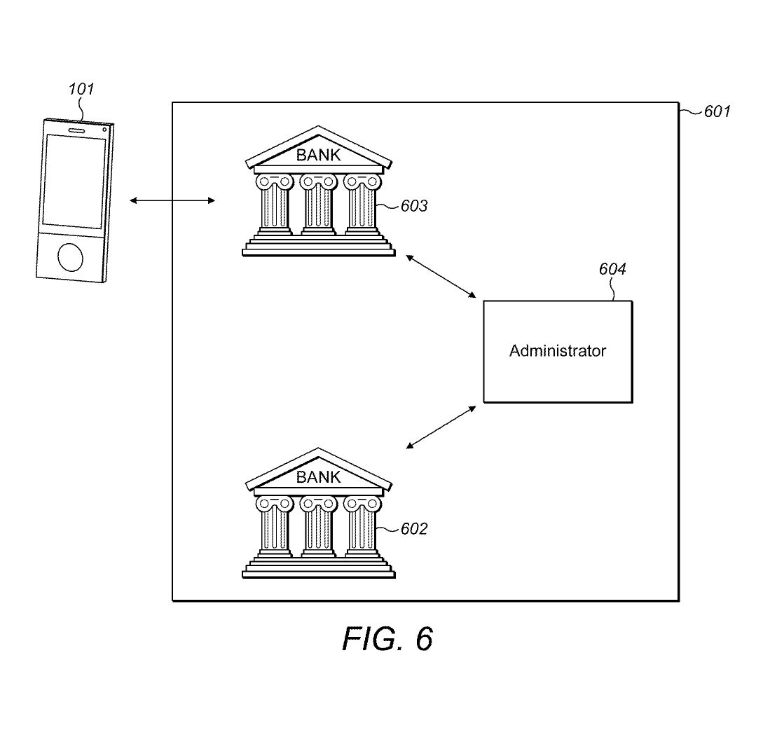

FIG. 6 shows a system for implementing automatic crediting according to an embodiment of the invention; and

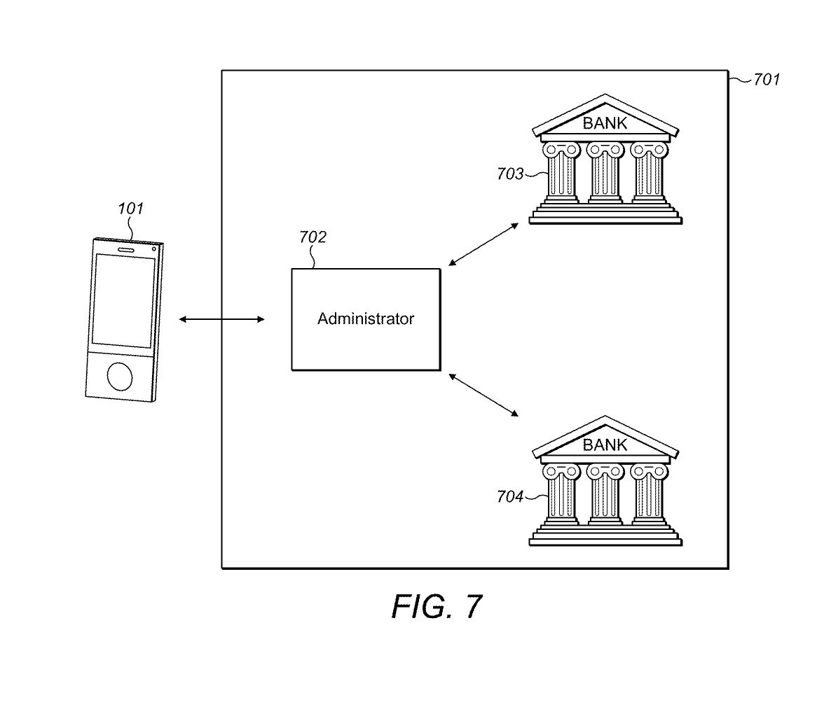

FIG. 7 shows a system for implementing automatic crediting according to an embodiment of the invention.

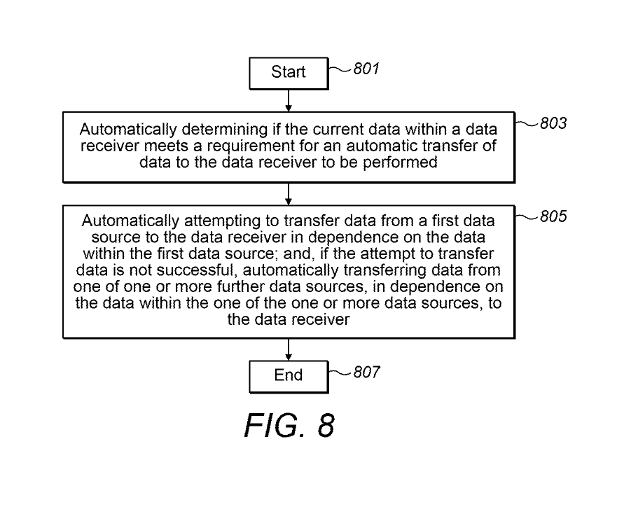

FIG. 8 shows a flow chart of computer-implemented processes performed according to an embodiment of the invention.

### DETAILED DESCRIPTION

Embodiments of the invention provide an improved method and system for implementing the automatic transfer of data. Embodiments improve on known systems by both greatly increasing the amount of control that users have and improving the functionality of the system to thereby provide an improved user experience.

Embodiments are described below with reference to the automatic crediting of prepaid accounts, such as prepaid cards. However, although this is a particularly preferred application of embodiments of the invention, embodiments are in no way restricted to this application and the described techniques are more generally applicable to any application that involves the automatic transfer of data.

According to embodiments, a user of one or more prepaid accounts is able to control the automatic crediting arrangements of each of the prepaid accounts with, for example, an app on a smartphone or by accessing a web page using any computing device. For each of the prepaid accounts, the user is able to easily control when crediting is performed, the amount of the crediting, the funding source for topping up the account, back-up funding sources, and notifications that the user receives. Advantageously, this results in a greatly improved user experience, in particular resulting in fewer transactions being rejected due to insufficient funds to thereby reduce the overall data traffic burden on the system.

Embodiments are described in more detail below with reference to the accompanying figures.

FIG. 1 shows a display of a user interface of a user device 101. The user device 101 is a user's mobile telephone and the mobile telephone is executing an application, or app, according to an embodiment. The application displays representations of each of the prepaid accounts of the user that it controls. The displayed representations are selectable by the user and, as described in more detail below, the user is able control the automatic crediting of a selected account. Advantageously, user experience is improved by the user being able to centrally manage all of their prepaid accounts using the same application.

FIG. 2 shows a display after one of the representations of the prepaid accounts shown in FIG. 1 has been selected by the user and the user has also selected an option for allowing the user to specify an account as a primary funding source for providing the funds for crediting the selected prepaid account.

After a user has selected the primary funding source, the user may then select one or more back-up funding sources that are to be used if an automatic crediting operation is required but there are insufficient funds in the primary funding source, or if the transaction from the primary funding source fails for any other reason, for the crediting to be performed. The user's selection of a primary and one or more back-up funding sources may be entered into the application as a prioritised list of funding sources that defines the sequence in which they are to be used in attempts to automatically-credit the selected prepaid account.

Advantageously, the functionality of the automatic crediting system is improved by ensuring that the funds for an automatic crediting operation are provided from one or more reserve funding sources if a preferred funding source has insufficient funds available or otherwise fails to transact.

FIG. 3 shows a display after one of the representations of the prepaid accounts shown in FIG. 1 has been selected by the user and the user has also selected an option for allowing the user to control the automatic crediting conditions, or parameters, of the account.

The user is able to control the value of the balance in the account that triggers an automatic crediting operation to be performed and the amount that the account is credited by. Preferably, the display has both sliders and text boxes for allowing the user to easily set the conditions, i.e. parameters. The sliders allow the user to easily set the conditions to standard values whereas the text box allows a user to enter conditions as any values.

Advantageously, the user's control of the conditions by which automatic crediting is performed is greatly improved.

FIG. 4 shows a display after one of the representations of the prepaid accounts shown in FIG. 1 has been selected by the user and the user has also selected an option for allowing the user to control notifications, that may be in the form of messages and alerts, that are provided by the automatic crediting system.

As shown in FIG. 4, a user is able to easily enter their contact details, which may be an email address and/or a mobile telephone number. Telephone numbers may be entered with international dialing codes to ensure operation in all territories. The user can also choose to receive either an SMS or an email when the balance of the prepaid account needs to be credited and the actual crediting of the account has occurred.

Although not shown in FIG. 4, a user may be presented with numerous other options for selecting types of notifications that are received. For example, a user may choose to receive a summary message as shown in FIG. 5. The message, that is automatically generated every week, informs the user of the balances on the account at the start and end of the week, the number of automatic crediting operations that have been performed and the total amount of money spent during the week.

Other notifications that a user may choose to receive are described below.

An alert may be received whenever a transaction has occurred that is above a set threshold level, e.g. £30. The threshold level may be a default threshold level set by the system operator or a threshold level set by the user. The alert may comprise the amount of the transaction and a contact number, that may be in an international format, for the user to call if the use was not authorised.

An alert may be generated when the account has been used to make an overseas transaction. The alert may state when and where the use was, the amount of the transaction and a contact number, that may be in an international format, for the user to call if the use was not authorised.

An alert may be generated to inform the user that a balance is below a set threshold level, e.g. £10. Similarly, an alert may be generated to inform the user that a balance is above a set threshold level, e.g. £100. The threshold levels may be a default threshold levels set by the system operator or a threshold levels set by the user.

A message may be generated that informs a user that an automatic crediting operation is required, provides a time and date of when this will occur and what funding source will be used to provide the funds. The message may contain a selectable option that, if selected by a user, prevents the automatic crediting operation from occurring.

Alternatively, a message may be generated that informs a user that a crediting operation is required and what the current primary funding source for crediting the prepaid account is. No time or date of the crediting operation are provided as this will not occur automatically. However, the message provides the user with a selectable option for instructing the crediting operation to occur. In this embodiment, the system automatically detects when an automatic crediting operation is required, and has in place all of the arrangements for the crediting to occur, but awaits a response from a prompt sent to the user before the crediting operation is performed. This is particularly useful option for a user to select if the user wishes to temporarily suspend automatic payments being made in order to take full control of their current expenditure.

A message may be generated that provides a user with confirmation that a crediting operation has occurred and explicitly specifies which prepaid account has been credited.

A message may be generated that provides a user with operational data of the funding source. For example the message may inform the user that a card being used to credit the account has expired, or will expire soon.

A message may be generated in dependence on determined location data of where a prepaid account has been used and/or by the current geographical location of a user's device. The messages may include, for example, marketing data based on the determined location data. The messages may, for example, comprise a 2d barcode, such as a QR code, for redeeming offers. Vouchers provided with the messages could be stored by the user device 101 for future use.

Advantageously, such notifications provide the user with important and useful data regarding their prepaid account(s). A user is able select what types of messages and alerts are received and to tailor the service to their preferences.

FIG. 6 shows a system for providing automatic crediting of a prepaid account according to an embodiment.

The system comprises a user device 101 and an administrative system 601. The user device 101 and the administrative system 601 operate together in order to provide the services of all of the above-described embodiments.

The administrative system 601 comprises a first entity 603, a second entity 602 and an administrator 604. When a crediting operation is required, the first entity 603, that may be an issuer, initiates a crediting operation. The crediting operation initiated by first entity 603 may have been initiated in response to an instruction from the user device 101. The first entity 603 communicates with the administrator 604 that in turn communicates with the second entity 602 that is the funding source. The funds for performing the crediting operation are then drawn from the second entity 602 and credited to the prepaid account. Each of the first and second entities may be, for example, a prepaid issuer, a bank or any type of e-money institution. The administrator 604 may be a card scheme, such as MasterCard®, and may provide other financial and technology systems that work in conjunction with embodiments.

FIG. 7 shows alternative system for providing automatic crediting of a prepaid account according to an embodiment.

The system comprises a user device 101 and an administrative system 701. The user device 101 and the administrative system 701 operate together in order to provide the services of all of the above-described embodiments.

The administrative system 701 comprises a first entity 704, a second entity 703 and an administrator 702. When a crediting operation is required, the administrator 702 initiates a crediting operation. The crediting operation initiated by administrator 702 may have been initiated in response to an instruction from the user device 101. The administrator 702 communicates with the second entity 703, that is the funding source for the crediting operation, to draw the required funds for the crediting operation. The administrator 702 then performs the crediting operation and then communicates with the first entity 704, that may be an issuer, to inform the first entity 704 of the successful crediting operation. Each of the first and second entities may be, for example, a prepaid issuer, a bank or any type of e-money institution. The administrator 702 may be a card scheme, such as MasterCard®, and may provide other financial and technology systems that work in conjunction with embodiments.

In the embodiments shown in FIGS. 6 and 7, the first entity 603, 704 administrator 604, 702 and second entity 602, 703 comprise computing systems such as servers. The prepaid account that is credited and the account of the funding source for crediting the prepaid account may be supported by the same entity and a single computing system may provide the above-described operations of a first and second entity.

Further communications between the user device 101 and the administrator 604, 702 may also occur in order for the user device 101 to provide the administrator 604, 702 with the set conditions and data of the funding sources for the automatic crediting operations and the user's preferences, such as what types of messages and alerts to receive.

Also provided, but not shown in FIGS. 6 and 7, are communications devices for sending notifications to the user device 101. The communications devices are able to send and receive instructions, and any other type of data, to the user device 101 and/or the administrator 604, 702, or any other component of the administrative system 601, 701. Since the user device 101 may be a mobile terminal, the communications devices include devices capable of communicating wirelessly.

FIG. 8 shows a flow chart of a computer-implemented process performed according to an embodiment of the invention.

In step 801, the process begins.

In step 803, it is automatically determined if the current data within a data receiver meets a requirement for an automatic transfer of data to the data receiver to be performed.

In step 805, it is automatically attempted to transfer data from a first data source to the data receiver in dependence on the data within the first data source; and, if the attempt to transfer data is not successful, data is automatically transferred from one of one or more further data sources, in dependence on the data within the one of the one or more data sources, to the data receiver.

In step 807, the process ends.

Many modifications and variations may be made to the above-described embodiments within the scope of the invention.

In the above described embodiments, the user device 101 is a mobile terminal.

Embodiments also include the user device 101 being any other type of computing device, such a desktop or laptop computer, smartphone or tablet. It is also not necessary for a specific program to be executed by the user device 101 as in the above-described embodiments and the user interaction with the automatic crediting system may alternatively be performed by a user accessing a web page through a standard web browser.

In the above-described embodiments, notifications are sent by SMS or email. However, any other communications technique may be used to convey the messages and alerts to a user device 101.

FIG. 1 shows the user having two prepaid accounts supported by the automatic crediting system. Embodiments include the system supporting any number of prepaid accounts, including just one. If only one prepaid account is supported, this may be automatically selected so that the screen for selecting one of the prepaid accounts as shown in FIG. 1 is not shown. Likewise, if multiple accounts are used, then one may be automatically selected by user preference, with an option to go and select any other account at any other time.

Embodiments are in no way limited to the crediting of funds in prepaid accounts and the techniques described herein may be used to improve the user experience in any application that requires the automatic transfer of data.

Other embodiments of the invention will be apparent to those skilled in the art from consideration of the specification and practice of the embodiments disclosed herein. It is intended that the specification and examples be considered as exemplary only, with a true scope and spirit of the invention being indicated by the following claims. In addition, where this application has listed the steps of a method or procedure in a specific order, it may be possible, or even expedient in certain circumstances, to change the order in which some steps are performed, and it is intended that the particular steps of the method or procedure claims set forth herebelow not be construed as being order-specific unless such order specificity is expressly stated in the claim.

1. A computer-implemented method of automatically transferring data to each of one or more data receivers, the method comprising, for each data receiver:
automatically determining if the current data within the data receiver meets a requirement for an automatic transfer of data to the data receiver to be performed; and, in dependence on the requirement being met:
automatically attempting to transfer data from a first data source to the data receiver in dependence on the data within the first data source;
and, if the attempt to transfer data is not successful, automatically transferring data from one of one or more further data sources, in dependence on the data within the one of the one or more data sources, to the data receiver.

2. The method according to claim 1, further comprising receiving, by a user interface of a user device, for each of the one or more data receivers, one or more of:
data on the data receiver;
data on a plurality of data sources;
data describing the requirement to be met by the data within the data receiver for an automatic transfer of data to the data receiver to be performed; and
data describing the data to be transferred to the data receiver.

3. The method according to claim 1, further comprising:
displaying, on the user interface of the user device, selectable icons representing each of the one or more data receivers; and
determining one of the one or more data receivers in dependence on a user's selection of the displayed icons.

4. The method according to claim 3, further comprising:
displaying, on the user interface of the user device, one or more adjustable sliders and/or one or more data boxes;
receiving data dependent on a user's operations on the one or more adjustable sliders and/or one or more data boxes; and
determining data describing the requirement to be met by the data within the determined data receiver for an automatic transfer of data to the determined data receiver to be performed and/or data describing the data to be transferred to the determined data receiver in dependence on the user's operations on the one or more adjustable sliders and/or one or more data boxes.

5. The method according to claim 3, further comprising:
displaying, on the user interface of the user device, a plurality of selectable icons representing data sources of the determined data receiver;
determining data providing an order of priority of the plurality of data sources in dependence on a user's selection received by the user interface; and
determining, for the determined data receiver, an order of the plurality of data sources for attempting to transfer data to the data receiver in dependence on the data providing the order of priority.

6. The method according to claim 2, further comprising:
displaying, on the user interface of the user device, one or more selectable options corresponding to receivable notifications;
determining a user's selection of one or more receivable notifications in dependence on a user's selection received by the user interface; and
transmitting the determined user's selection of receivable notifications to a system;
wherein each of the receivable notifications is associated with an event that defines when a notification, for displaying on the user interface of the user device, is sent to the user device by the system.

7. The method according to claim 6, further comprising:
the system receiving a determined user's selection of notifications from the user device; and
the system transmitting, for each of the determined user's selection of notifications, one or more notifications to the user device, in dependence on the event associated with the notification.

8. The method according to claim 7, wherein the event associated with a notification is dependent on one or more of:
data within a data receiver meeting the requirement for an automatic transfer of data to the data receiver to be performed;
data from a data source being received by a data receiver;
operational data of one or more data sources;
use data of one or more data receivers; and
a periodically defined time instance.

9. The method according to claim 7, further comprising the system sending one or more notifications to the user device as an SMS message and/or as an email.

10. The method according to claim 6, wherein the content of a notification sent to the user device is dependent on one or more of:
data within one or more data receivers;
data within one or more data sources;
data transferred into one or more data receivers over a predetermined period of time;
a current location of the user device; and
a location of use of the user device.

11. The method according to claim 6, further comprising transmitting data between the user device and the system over the internet.

12. The method according to claim 2, wherein the user device comprises a computing device.

13. The method according to claim 1, wherein the one or more data receivers and data sources are accounts, comprising financial data, supported by one or more computing systems.

14. The method according to claim 13, wherein the one or more data receivers are prepaid accounts.

15. The method according to claim 13, wherein the one or more data receivers are prepaid accounts of prepaid cards.

16. A system comprising at least one computer programmed to:
automatically determining if current data within a data receiver meets a requirement for an automatic transfer of data to the data receiver to be performed; and, in dependence on the requirement being met:
automatically attempting to transfer data from a first data source to the data receiver in dependence on data within the first data source;
and, if the attempt to transfer data is not successful, automatically transferring data from one of one or more further data sources, in dependence on data within the one of the one or more data sources, to the data receiver.

17. A user device comprising at least one computing device programmed to:
receive, for each of one or more data receivers, one or more of:
data on the data receiver;
data on a plurality of data sources;
data describing a requirement to be met by the data within the data receiver for an automatic transfer of data to the data receiver to be performed; and
data describing the data to be transferred to the data receiver;
displaying selectable icons representing each of the one or more data receivers; and
determining one of the one or more data receivers in dependence on a user's selection of the displayed icons.
